(19) United States
(12) Patent Application Publication
(10) Pub. No.: US 2026/0114386 A1
(43) Pub. Date: Apr. 30, 2026

(54) METHOD FOR REDUCING THE GLOBAL GREENHOUSE EFFECT

(71) Applicant: Stefan HENSCHEN, Aachen (DE)

(72) Inventor: Stefan HENSCHEN, Aachen (DE)

(21) Appl. No.: 18/835,186

(22) PCT Filed: Jan. 31, 2023
(86) PCT No.: PCT/EP2023/052231

§ 371 Date: Aug. 1, 2024

(30) Foreign Application Priority Data
Feb. 1, 2022 (DE) 10 2022 102 326.5

(51) Int. Cl. A01G 15/00; C01B 13/02

(52) U.S. Cl. CPC A01G 15/00; C01B 13/024

(57) ABSTRACT

The present application relates to a method for reducing the global greenhouse effect, in which a gas that is inactive for long-wave radiation is introduced into the Earth's atmosphere, preferably the troposphere, whereby the total volume of the Earth's atmosphere is increased. According to the invention, in order to provide an alternative method for reducing the global greenhouse effect, it is provided that a mass of the climate-damaging gases contained in the Earth's atmosphere remains constant, so that the increase in the total volume causes a relative reduction in the content of climate-damaging gases contained in the Earth's atmosphere, based on the total volume of the Earth's atmosphere.

### INTRODUCTION

Current climate models predict an increase in the global average temperature of 1.5° C. by 2030 as a result of man-made climate change. Man-made climate change is due, among other things, to the steadily increasing proportion of carbon dioxide in the Earth's atmosphere. Carbon dioxide largely allows short-wave radiation to pass through, while it absorbs longer-wave thermal radiation and finally emits it again. Part of the emitted radiation is directed towards the Earth's surface, which is heated up as a result and also emits thermal radiation. This is again absorbed and emitted by the carbon dioxide molecules contained in the Earth's atmosphere. This process is ongoing. Overall, the system is therefore warmed up, which leads to an increase in the global average temperature. The emission of methane due to the thawing permafrost also contributes to the greenhouse effect. The consequences of climate change are already being felt in the form of droughts, storms and floods.

In order to reduce man-made climate change as a result of the increase in carbon dioxide in the Earth's atmosphere, a large number of methods are known. Methods are known which provide for ocean fertilization or propose removing carbon dioxide from the Earth's atmosphere. In addition, it is proposed to increase the alkalinity of the seawater or to largely reforest it. However, ocean fertilization or even an increase in seawater alkalinity would have significant impacts on oceanic ecosystems and pH with unknown consequences. At the same time, these methods can cause the emission of other greenhouse gases such as methane. In particular, the extraction of carbon dioxide from the air poses a problem with the long-term storage of the gas. Suitable storage systems would have to have a corresponding capacity and long-term tightness. Large areas are required for reforestation, which are not available due to urbanization, agriculture and desertification.

In addition, a variety of methods are known to reduce the proportion of solar radiation incident on the Earth's surface, such as the installation of mirror surfaces in space, the introduction of aerosols in the stratosphere, the brightening of clouds over the sea or even the whitening of surfaces. However, the above measures are associated with considerable effort or, in turn, generate large amounts of carbon dioxide during the reaction.

### OBJECT It is therefore the object of the present invention to develop an alternative method for reducing the greenhouse effect.

### SOLUTION

The above object is achieved by a method as claimed in claim 1. The method provides for introducing a gas that is inactive for long-wave radiation into the Earth's atmosphere, preferably the troposphere, in a correspondingly large amount, whereby the total volume of the Earth's atmosphere is increased. A mass of the climate-damaging gases contained in the Earth's atmosphere remains constant, so that the increase in the total volume causes a relative reduction in the content of climate-damaging gases contained in the Earth's atmosphere, based on the total volume of the Earth's atmosphere.

In the context of the present invention, a “gas that is inactive for long-wave radiation” is understood to mean, in particular, a gas which, due to its chemical structure, is not capable of absorbing and emitting long-wave radiation. This is due to the fact that corresponding diatomic gas molecules have a symmetrical structure and for this reason are not excited by long-wave radiation. The gas therefore acts transparently for long-wave radiation. Long-wave radiation, which also includes infrared radiation, is understood here to mean electromagnetic radiation in the wavelength range from about 780 nm to 1 mm.

The method according to the invention has many advantages. In particular, the method makes it possible to reduce the greenhouse effect. The main components of the Earth's atmosphere are nitrogen with a volume fraction of around 78%, oxygen with a volume fraction of around 21% and argon with a volume fraction of around 0.9%. There are also other trace gases, in particular carbon dioxide with a volume fraction of around 400 ppm (parts per million). Carbon dioxide in particular acts as a climate-damaging gas here, since it absorbs infrared radiation and prevents subsequent emission of infrared radiation from the Earth's surface, thus leading to global warming.

When the gas that is inactive for long-wave radiation is introduced into the Earth's atmosphere, preferably into the troposphere, the gases already contained in the Earth's atmosphere are mixed with the introduced gas as a result of weather events, thermal influences and the Coriolis force, so that the introduced gas is uniformly distributed in the Earth's atmosphere.

At the same time, according to Dalton's law, the partial pressure of this gas is increased due to the introduction of the gas, while the partial pressures of the gases already contained in the Earth's atmosphere do not change. As a result, the air pressure that can be measured on Earth changes, with the air pressure being increased accordingly by the partial pressure of the gas introduced.

Due to the increased air pressure, in addition to the increase in the total mass of the Earth's atmosphere according to Boyle Mariotte's law, there is also an increase in the total volume of the gases contained in the Earth's atmosphere. Since the mass of the climate-damaging gases already contained in the Earth's atmosphere, in particular carbon dioxide, remains constant, the increase in the total volume causes a relative reduction in the content of climate-damaging gases already contained in the Earth's atmosphere, based on the total volume of the Earth's atmosphere. In other words, the mass of climate-damaging gases contained in the Earth's atmosphere is not changed by the method. The introduced gas itself is specifically inactive for long-wave radiation and therefore cannot absorb long-wave radiation and therefore does not have a harmful effect on the climate.

Due to the increased total volume, the average distances between the molecules of the climate-damaging gases increase, with the result that a higher proportion of infrared radiation can be emitted without being absorbed by the carbon dioxide molecules. Overall, the greenhouse effect can thus be reduced. As a result, the global average temperature will decrease. The method is therefore particularly suitable for curbing man-made climate change and should be included in an economic analysis to avoid climate damage, which occurs in particular after the global average temperature increase has exceeded 1.5° C.

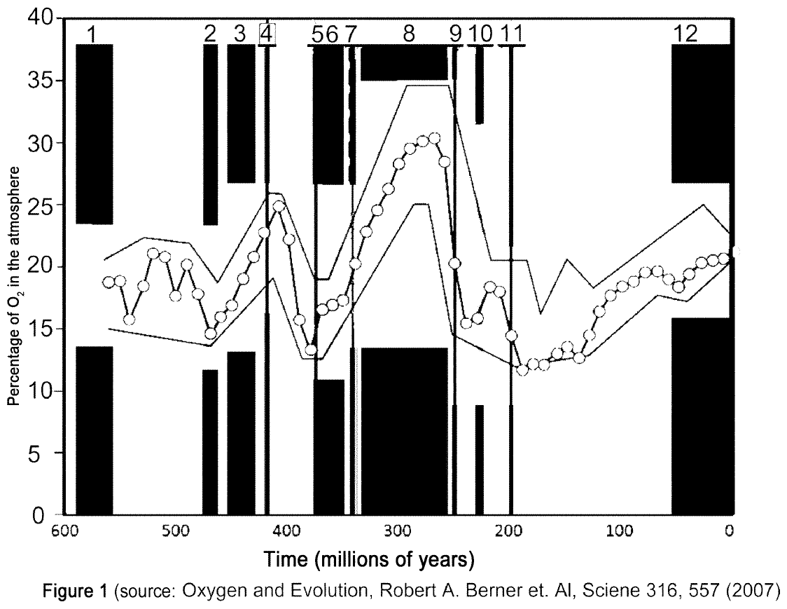

The effect described above was able to be established when examining the temporal change in the proportion of carbon dioxide and oxygen and the temporal change in global average temperature in a period from about 80 million years ago to about 65 million years ago, which corresponds to the beginning of the ice age: by means of an isotope analysis it could be determined that the proportion of oxygen in the Earth's atmosphere at the beginning of the ice age rose by 5%, as can be seen from FIG. 1.

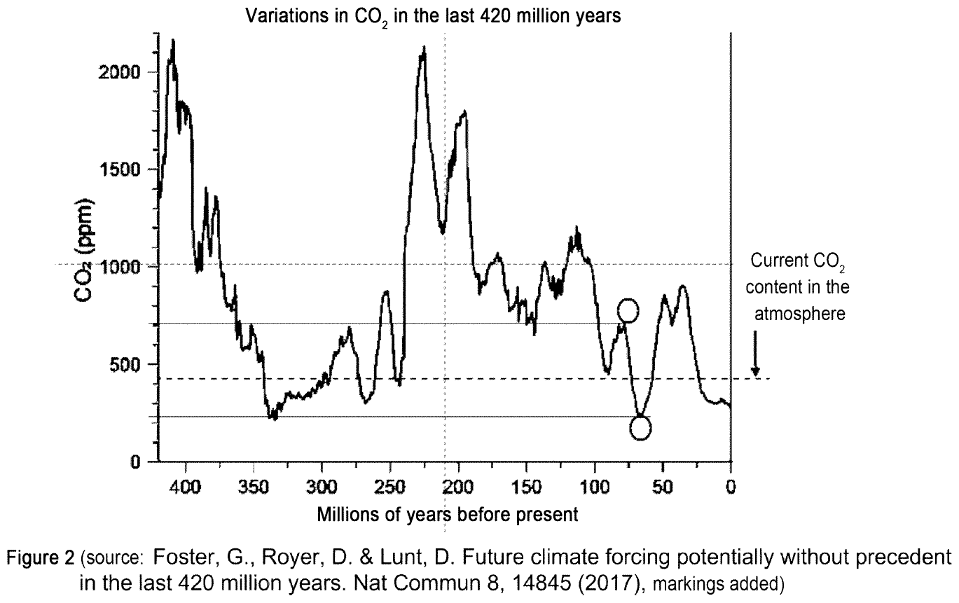

During the same period, the proportion of carbon dioxide in the Earth's atmosphere fell from 710 ppm (parts per million) to 220 ppm (parts per million) as shown in FIG. 2.

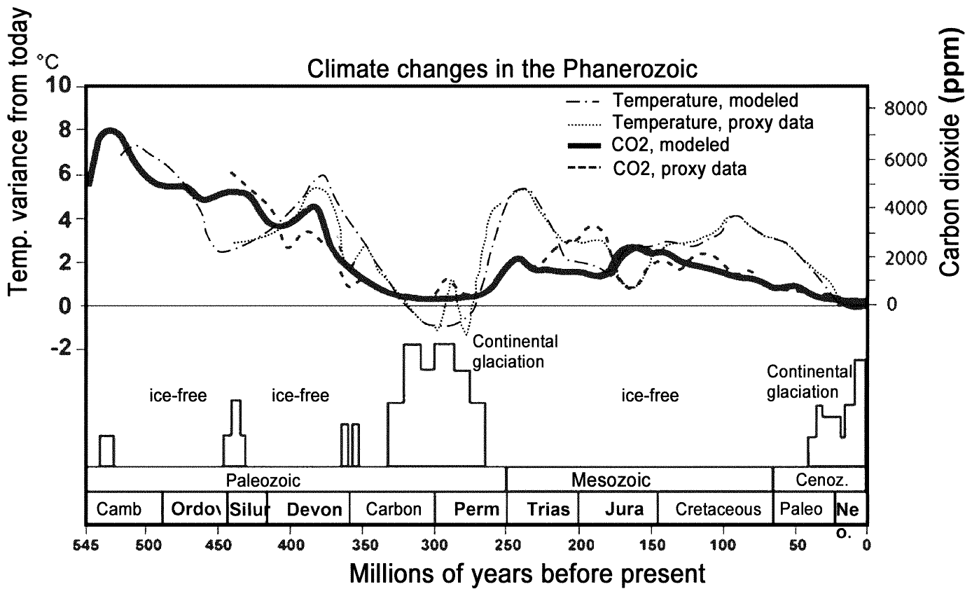

In the same period, the global average temperature dropped to 2° C., as can be seen in FIG. 3.

In summary, it can be established that an increase in the proportion of oxygen in the Earth's atmosphere correlates with a decrease in the global average temperature.

According to a preferred embodiment of the invention, it is provided that the amount of gas introduced is in a range between 0.1% and 30.0% based on the total volume of the Earth's atmosphere. It has been found that such a quantity can be generated with technically and economically justifiable effort and is also well suited to leading to an effective increase in the total volume of the Earth's atmosphere, so that the mean distances between the climate-damaging molecules are increased in such a way that a significant reduction in the global average temperature can be caused.

A preferred embodiment of the invention provides that the introduced gas contains or consists of oxygen and/or nitrogen. Due to their “climate neutrality”, these two gases have proven to be particularly advantageous for enriching the Earth's atmosphere with a gas. The reason for this is that the introduction of these gases leads to the desired increase in volume of the Earth's atmosphere without having a negative impact on the climate. Also, the required changes in the proportion of these gases are harmless to the biosphere. It is known that oxygen and nitrogen do not lead to an increase in the global average temperature because they are inactive for longer-wave thermal radiation, so they do not absorb and then emit it and therefore do not contribute to the greenhouse effect. In addition, in particular, an increase in the proportion of oxygen in the Earth's atmosphere to a certain extent advantageously has no negative impact on humans and the ecosystem of the Earth, so that the proportion of oxygen can be increased without concern. In particular, also taking into account the increasing deforestation of rainforests and the associated reduction in the proportion of oxygen obtained by photosynthesis, increasing the proportion of oxygen is particularly advantageous.

Likewise, an increase in the proportion of oxygen in the Earth's atmosphere leads to molecular compounds that are formed in biological and chemical processes. These molecular compounds can in turn use the carbon dioxide contained in the Earth's atmosphere and/or the carbon contained therein for new molecular compounds and thus advantageously remove carbon dioxide from the Earth's atmosphere. In other words, increasing the proportion of oxygen also indirectly leads to a reduction in the proportion of carbon dioxide, with the reduction in the proportion of carbon dioxide in the Earth's atmosphere also having a positive effect on the climate.

For example, by increasing the proportion of oxygen from 21% to 21.5%, the carbon dioxide concentration can be reduced by 2.4 ppm (parts per million). 2.4 ppm (parts per million) is the current annual amount of carbon dioxide released into the Earth's atmosphere. This is a purely physical consideration. The possible reduction of the carbon dioxide concentration through biological and chemical processes as described above is not taken into account here. An increase in the proportion of oxygen from 21% to 21.5% based on the total volume of the Earth's atmosphere is therefore particularly preferred.

Provision can also preferably be made here for nitrogen to be introduced at the same time in order to be able to maintain the current relative volume ratio of nitrogen to oxygen. Provision can preferably be made here for the proportion of oxygen that is introduced into the Earth's atmosphere to be balanced out by introducing nitrogen, preferably in a ratio of 3:1, more preferably a ratio of 4:1, with nitrogen making up the higher proportion, so that the natural relative volume ratio can be maintained. It can be provided here that the proportion of oxygen is increased in a range from 0.1% to 15.0% based on the total volume, while the proportion of nitrogen is increased in a range from 0.1% to 45% based on the total volume. In addition, introducing nitrogen would further reduce the proportion of carbon dioxide in the Earth's atmosphere due to the associated increase in the total volume of the Earth's atmosphere. For example, nitrogen can be obtained by denitrification of nitrates, which can be extracted from large deposits in areas such as the Atacama Desert in Chile.

According to a preferred embodiment of the invention, it is provided that the introduced gas is obtained from the Earth's crust, preferably by means of a reduction process. Obtaining the gas from the Earth's crust can advantageously ensure that the method can be carried out on Earth. For example, fused-salt electrolysis can be used here as a reduction process in which oxides are reduced with the formation of oxygen and which is also intended to be used to obtain oxygen on the moon.

A further preferred embodiment of the invention here provides that the oxygen is obtained by reducing silicon dioxide, the silicon dioxide preferably being taken from desert sand. Desert sand is available in large, almost “inexhaustible” quantities and cannot be used in the construction industry due to its coarseness. Advantageously, the use of desert sand does not cause a shortage of other raw materials at the same time. However, another oxide occurring in the Earth's crust can also be used to obtain the oxygen.

According to a preferred embodiment of the invention it is further provided that a regenerative energy source, in particular solar energy and/or wind energy, is used at least partially, preferably completely, in the reduction method. Contrary to the known methods, only a small proportion of carbon dioxide, but preferably no further carbon dioxide, is thus produced during the removal of the carbon dioxide itself from the Earth's atmosphere. The method is therefore also largely climate-neutral. In particular, if oxygen is used as the gas to be introduced into the Earth's atmosphere and is obtained by reducing desert sand, the use of solar energy is particularly suitable due to the strong solar radiation in the corresponding desert regions.

1. A method for reducing the global greenhouse effect, in which a gas that is inactive for long-wave radiation is introduced into the Earth's atmosphere, preferably the troposphere, whereby the total volume of the Earth's atmosphere is increased, wherein a mass of the climate-damaging gases contained in the Earth's atmosphere remains constant, so that the increase in the total volume causes a relative reduction in the content of climate-damaging gases contained in the Earth's atmosphere, based on the total volume of the Earth's atmosphere.

2. The method as claimed in claim 1, wherein the amount of gas introduced is in a range between 0.1% and 30.0% based on the total volume of the Earth's atmosphere.

3. The method as claimed in claim 1, wherein the introduced gas contains or consists of oxygen and/or nitrogen.

4. The method as claimed in claim 1, wherein the introduced gas is obtained from the Earth's crust, preferably by means of a reduction process.

5. The method as claimed in claim 4, wherein the oxygen is obtained by reducing silicon dioxide, the silicon dioxide preferably being taken from desert sand.

6. The method as claimed in claim 4, wherein a regenerative energy source, in particular solar energy and/or wind energy, is used at least partially, preferably completely, in the reduction process.

7. The method as claimed in claim 2, wherein the introduced gas contains or consists of oxygen and/or nitrogen.

8. The method as claimed in claim 2, wherein the introduced gas is obtained from the Earth's crust, preferably by means of a reduction process.

9. The method as claimed in claim 3, wherein the introduced gas is obtained from the Earth's crust, preferably by means of a reduction process.

10. The method as claimed in claim 5, wherein a regenerative energy source, in particular solar energy and/or wind energy, is used at least partially, preferably completely, in the reduction process.
